(19) United States
(12) Patent Application Publication
(10) Pub. No.: US 2014/0065034 A1
(43) Pub. Date: Mar. 6, 2014

(54) MICROFLUIDIC DEVICE AND METHOD OF FABRICATING MICROFLUIDIC DEVICES

(71) Applicants: Yun Zheng, Rockville, MD (US); Edward Wassell, LaureI, MD (US); Manuel Balvin, Springfield, VA (US); Stephanie Getiy, Washington, DC (US)

(72) Inventors: Yun Zheng, Rockville, MD (US); Edward Wassell, LaureI, MD (US); Manuel Balvin, Springfield, VA (US); Stephanie Getiy, Washington, DC (US)

(21) Appl. No.: 13/601,194

(22) Filed: Aug. 31, 2012

(51) Int. Cl. B01L 3/00

(52) U.S. Cl. CPC B01L 3/502707
USPC 422/502; 156/272.2; 156/250; 156/64; 216/33

(57) ABSTRACT

Lab-on-a-chip microfluidic devices having micro-channels able to withstand an internal channel pressure of more than 4,000 psi are described. The micro-channels have rounded cross-sections that prevent turbulent flow within a fluid conveyed within the channel. The channel may have serpentine-shaped length extending between a channel inlet and a channel outlet, the channel thereby being of sufficient length to observe both the stationary and moving phases of the fluid in a chip having a sufficiently small footprint that it is suitable for incorporation into a miniaturized spectrometer. Methods of fabricating lab-on-a-chip microfluidic devices are described by etching recesses in chip substrates such that a first substrate recess mirrors a second substrate recess in an opposed orientation, aligning the substrates such the recesses cooperatively define a micro-channel having a rounded cross-section, and bonding the substrates to define a smooth-walled micro-channel.

### GOVERNMENT INTERESTS

The subject matter described herein was made in the performance of work under a NASA contract and by employees of the United States Government. As such, the subject matter disclosed herein is subject is subject to the provisions of Public Law 96-517 as codified in 35 U.S.C. §202, and may be manufactured and used by or for the Government for governmental purposes without the payment of any royalties thereon or therefore.

### BACKGROUND

1. Field

The aspects of the present disclosure relate generally to micro-channels for microfluidic devices. More specifically, the aspects of the present disclosure relate to a lab-on-a-chip analytical device having at least one micro-channel and methods for manufacturing such devices.

2. Description of Related Art

A lab-on-a-chip (LOC) is a microfluidic device used for studying a fluid conveyed within the chip. They typically contain microstructures, such as micro-channels, pumps, valves, reservoirs, mixers, and reaction chambers. They may also contain a plurality of microstructures that cooperate to analyze a fluid introduced into the chip. The devices are used to detect bacteria, viruses, and cancer using extremely small volumes of fluid (e.g. microliters, nanoliters, or picoliters). They may also be used to determine the chemical composition of a fluid introduced into the chip by manipulating the fluid, such as by introducing reagents or mixing fluids within the chip, or by delivering fluid to an analytical device, such as liquid chromatographic columns, electrospray ionization mass spectrometers, and chemical detectors. One potential use of such devices is remote fluid analysis using an optical microscope and/or spectroscopy to analyze fluid chemistry.

Microfluidic device features may be formed by carving recesses into in the device substrate. A second element (i.e. cover) is then fixed to the substrate, covering the recess and defining chip microstructure. The chip substrate may be fabricated from glass, silicon, or plastics (organic-based polymers). Different substrate materials have different advantages and disadvantages, and a certain material may be more desirable than others for a given application. For example, glass is chemically inert, and is desirable in applications where the chemical makeup of a fluid is of interest. Plastics are less desirable in such applications, plastics tending to leach organics into fluids contacting the structure. Silicon is also relatively inert, and has the additional advantage that electrical devices can easily be integrated into silicon substrates using conventional semiconductor manufacturing processes.

Chip substrate recesses may be formed several ways. One way is to mechanically abrade the substrate by selectively sandblasting or powder blasting the substrate surface. Another way is through chemically etching the substrate surface using a chemical that reacts with the substrate material. Each of these techniques pose challenges to fabricating microfluidic devices, the first being difficult to control with surface masking, and the second tending to leave unusual contours in the recess cross-section which influence the usual fluid mechanics associated in manipulating small fluid volumes.

Another problem with conventional methods of fabricating LOC microstructures is the bond between the substrate having the recess and the overlying cover material. As a consequence, conventional microstructures like micro-channels have relatively low maximum channel pressures. For example, chips available from Micronit Microfluidics BV can only sustain maximum channel pressures one the order of 100 bar (1,450 psi). Such chips are therefore unsuitable for applications where extremely high micro-channel pressures are expected, such as in-situ planetary exploration, where pressures of 276 bar (4,000 psi) are expected.

Yet another problem with conventional methods of fabricating chip microstructures is the resulting channel shape. For example, a flat cover presents a flat surface to the micro-channel. Similarly, conventional etching techniques typically result in micro-channels with square cross-sections. Flat surfaces and square cross-sections induce turbulences into fluid flow which may change the optical properties of the fluid, posing challenges to optical analysis techniques such as spectroscopy.

There therefore exists a need for an improved method for manufacturing a microfluidic device with at least one micro-channel capable handling high maximum channel pressures. Such chips should be able to withstand a maximum pressure of more than 276 bar (4,000 psi). The chip should also be adapted for easy miniaturized, high-pressure liquid chromatograph (HPLC) equipment. The chip should also be constructed so as to have both a small footprint and have a channel of sufficient length that both the stationary and mobile phases of fluid flowing through the channel can occur and be observed using an optical microscope. The chip micro-channel should also have micro-channel geometry that does not induce turbulence into fluid flowing through the channel. Finally, the chip should also have a leak tight micro-channel inlet and outlet connection such that the chip can be easily integrated with standard capillary tubes into conventional micro-electromechanical systems (MEMS) and nano-electromechanical systems (NEMS).

Accordingly, it would be desirable to provide a device that addresses at least some of the problems identified above.

### SUMMARY

As described herein, the exemplary embodiments overcome one or more of the above or other disadvantages known in the art.

One aspect of the exemplary embodiments relates to a method of making a microfluidic chip using a plurality of substrates having at least one recess. In one embodiment, a first recess is defined in at least one recess in a surface of a first substrate comprising a first material. A second recess is defined in a surface of a second substrate comprising a second material. The second substrate is inverted with respect to the first substrate. The second substrate is registered to the first substrate such that the at least one recess in the surface of the first substrate overlays the at least one recess in the surface of the second substrate. The registered second substrate is fixed to a first substrate using an anodic bond.

Another aspect of the disclosed embodiments relates to a microfluidic chip having a micro-channel. In one embodiment the chip comprises a first substrate having a first recess and a second substrate having a second recess. The second substrate is fixed to the first substrate with an anodic bond in a positional relationship such that the second substrate is registered to the first substrate. The registration results in a positional alignment wherein the first substrate recess and the second substrate recess cooperatively define the micro-channel. The micro-channel has a cross-section with an oval cross-section along at least a portion of a length of the micro-channel. The micro-channel wall is substantially smooth along at least a portion of a length of the micro-channel. A portion of the length of the micro-channel has a serpentine shape extending between an inlet and an outlet of the micro-channel.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and unless otherwise indicated, they are merely intended to conceptually illustrate the structures and procedures described herein.

### BRIEF DESCRIPTION OF THE DRAWINGS

In the drawings:

FIG. 1 is a perspective view of a microfluidic device incorporating aspects of the disclosed embodiments;

FIG. 2 is a perspective view of a microfluidic device incorporating aspects of the disclosed embodiments fabricated from a first and a second joined substrate;

FIG. 3 is a perspective view of a microfluidic device incorporating aspects of the disclosed embodiments having a micro-channel;

FIGS. 4A-4C are cross-sectional views of a micro-channel of a microfluidic device incorporating aspects of the disclosed embodiments;

FIGS. 5A and 5B are perspective views of a first and a second substrate, the substrates having mirroring recesses for a microfluidic device incorporating aspects of the disclosed embodiments;

FIGS. 6A-6D are plan views of exemplary embodiments of a microfluidic device incorporating aspects of the disclosed embodiments;

FIG. 7 is a flowchart of one embodiment of a method of fabricating a microfluidic device incorporating aspects of the present disclosure;

FIG. 8 is a flowchart of an embodiment of the defining a recess operation of the method of fabricating a microfluidic device shown in FIG. 7;

FIG. 9 is a flowchart of an embodiment of the registration operation of the method of fabricating a microfluidic device shown in FIG. 7; and

FIG. 10 is a flowchart of an embodiment of the anodic bonding operation of the method of fabricating a microfluidic device shown in FIG. 7.

### DETAILED DESCRIPTION OF THE DISCLOSED EMBODIMENTS

Detailed illustrative embodiments of example embodiments are disclosed herein. However, specific structural and functional details disclosed herein are merely representative for purposes of describing example embodiments. The example embodiments may, however, be embodied in many alternate forms and should not be construed as limited to only example embodiments set forth herein.

As used herein, the terms “front,” “rear,” “left,” “right,” “top,” “bottom,” “upper,” and “lower” refer to relative placement of features shown in the drawings. These terms do not indicate that any specific embodiment is limited in its orientation unless otherwise specified in the accompanying description. As used herein, the terms “first” and “second” are used to distinguish one element from another and do not refer to any particular order or positional relationship. For example, a first element could be termed a second element, and, similarly, a second element could be termed a first element, without departing from the scope of example embodiments.

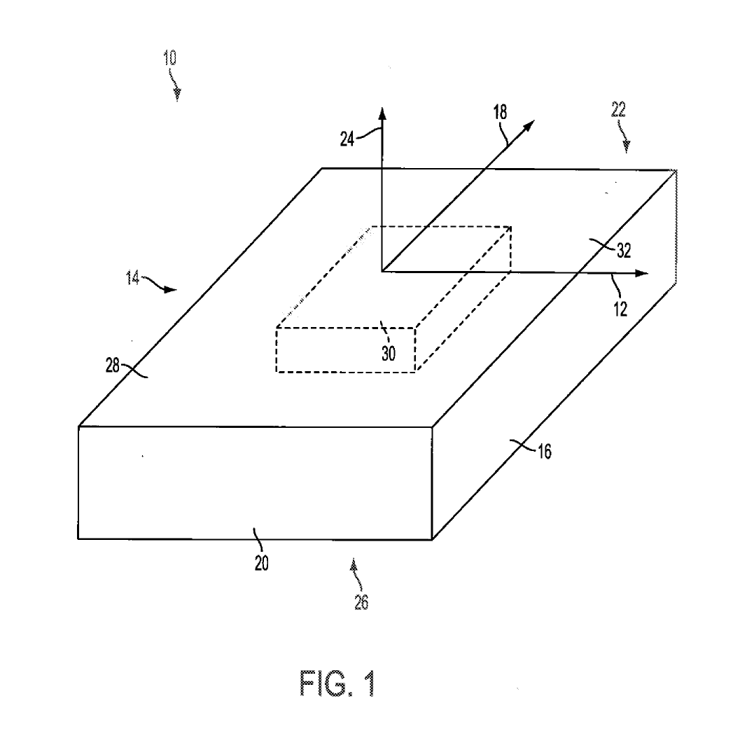

FIG. 1 shows a microfluidic device comprising a lab-on-a-chip 10 (LOC) incorporating aspects of the present disclosure. The aspects of the present disclosure are generally directed to a microfluidic device.

In the embodiment shown in FIG. 1, chip 10 comprises an x-axis 12, a left edge 14, and a right edge 16. The left edge 14 and the right edge 16 define substantially parallel chip surfaces, each surface being orthogonal with respect the x-axis 12. Chip 10 further comprises a y-axis 18, a front edge 20, and a rear edge 22. The front edge 20 and the rear edge 22 define substantially parallel chip surfaces, each surface being orthogonal with respect to the y-axis 18. Chip 10 also comprises a z-axis 24, a bottom surface 26, and top surface 28. The bottom surface 26 and the top surface 28 define substantially parallel chip surfaces, each surface being orthogonal with respect to the z-axis 24.

In an embodiment, surfaces (26, 28) define a chip having an approximately 5 millimeter by 5 millimeter footprint (x by y dimension). In another embodiment, surfaces (26, 28) define a chip having an approximately 5 millimeter by 10 millimeter footprint (x by y dimension). Advantageously, an approximately 5 millimeter by 5 millimeter chip size allows for fabrication of chip 10 in large numbers. For example, using 100 millimeter (4 inch) wafers, 72 chips may be fabricated. Chip 10 may be fabricated in correspondingly greater numbers using 200 millimeter (8 inch) or 200 millimeter (12 inch) wafers.

Chip 10 comprises at least one feature 30 and a volume 32. Volume 32 is defined by the chip edges (14, 16, 20, 22) and chip surfaces (26, 28). Feature 30 is disposed within volume 32, and comprises a microstructure having microfluidic functionality. Embodiments of feature 30 are valves, pumps, reservoirs, reaction chambers, and conduits. In an embodiment, the at least one feature comprises a micro-channel arranged to convey a small volume of fluid between an inlet and an outlet. In an embodiment, the micro-channel is arranged to convey a fluid from an inlet located on the chip edge (14, 16, 20, 22) or chip surface (26, 28). In an embodiment, the micro-channel is arranged to convey a fluid to an outlet located on the chip edge (14, 16, 20, 22) or chip surface (26, 28). In another embodiment, at least one of the micro-channel inlet 66 and outlet 68 is disposed within the chip volume 32, and is arranged to convey fluid between at least one other microstructure (not shown) within the chip 10.

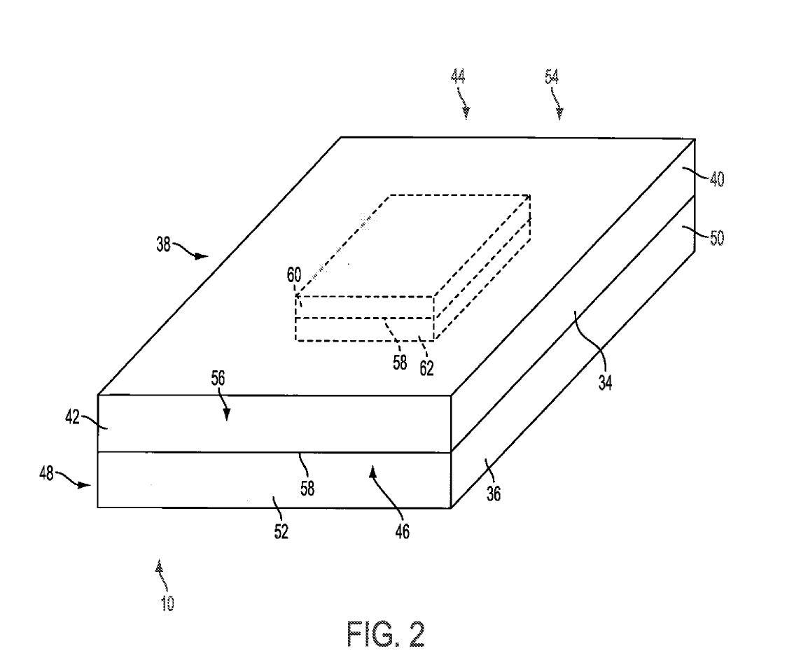

FIG. 2 shows an embodiment of a microfluidic chip 10 comprising a first substrate 34. The first substrate 34 comprises a left edge 38, a right edge 40, a front edge 42, a rear edge 44, and a bottom surface 46. The first substrate left edge 38 defines a portion of the chip left edge 14. The first substrate right edge 40 defines a portion of the chip right edge 16. The first substrate front edge 42 defines a portion of the chip front edge 20. The first substrate rear edge 44 defines a portion of the chip rear edge 22. The first substrate bottom surface 46 is substantially parallel to the chip top and bottom surfaces (26, 28).

As also shown in FIG. 2, microfluidic chip 10 comprises a second substrate 36. Second substrate 36 comprises a left edge 48, a right edge 50, a front edge 52, a rear edge 54, and a second substrate top surface 46. The second substrate left edge 48 defines a portion of the chip left edge 14. The second substrate right edge 50 defines a portion of the chip right edge 16. The second substrate front edge 52 defines a portion of the chip front edge 20. The second substrate rear edge 54 defines a portion of the chip rear edge 22. The second substrate top surface 56 is substantially parallel to the chip top and bottom surfaces (26, 28).

As further shown in FIG. 2, the chip 10 comprises an interface 58. In one embodiment, the interface 58 comprises a joint constructed from the first substrate bottom surface 46 and the second substrate top surface 56, the joint bonding first substrate 34 to second substrate 36. In an embodiment, the interface 58 substantially defines a plane comprising the x-axis 12 and y-axis IS. Interface 58 axially divides feature 30 into an upper portion 60 and a lower portion 62. In an embodiment, interface 58 divides evenly divides feature 30 into an upper portion 60 and a lower portion 62 wherein the upper portion 60 substantially mirrors the lower portion 62. In another embodiment, the interface 58 is disposed at non-normal angle with respect to the z-axis 24.

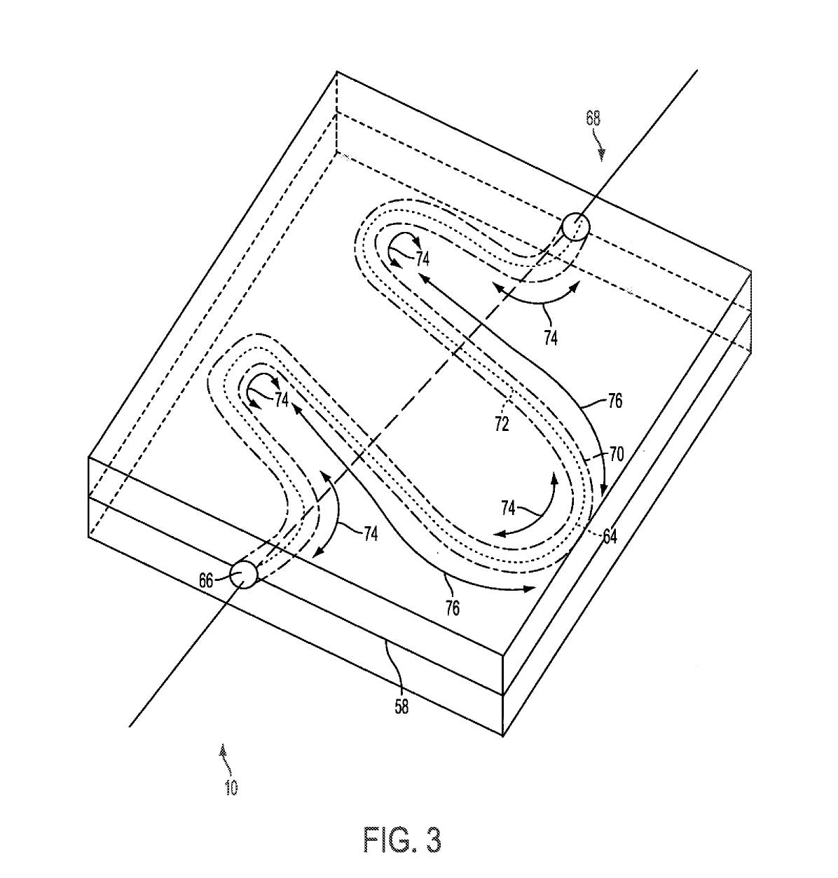

FIG. 3 shows a chip 10 wherein the feature 30 further comprises a micro-channel 64. The micro-channel 64 comprises an inlet 66, an outlet 68, a channel wall 70, and a length 72. Channel length 72 (shown in dotted lines in the figure) extends between the inlet 66 and the outlet 68, and substantially defines a cannula within the chip volume. In the embodiment shown in FIG. 3, the channel length 72 defines a serpentine-shaped channel extending from the channel inlet 66 to the channel outlet 68. The serpentine-shaped channel 64 has a plurality of radii 74 formed along its length. Advantageously, the radii 74 allow a successive portion 76 of the channel 64 to fold back upon a predecessor portion 78 of the channel 64, thereby allowing for greater channel length for a given area of chip area. In the embodiment shown in FIG. 3, channel inlet 66 and channel outlet 68 respectively define an entry and exit to the micro-channel 64 such that microstructures within the chip 10 are fluidly communicative with the environment outside the chip 10. As would be recognized by one of ordinary skill in the art, embodiments of chip 10 may comprise a plurality of micro-channels 64 defining independent channels in the chip volume. Embodiments of chip 10 may have at least one of a channel inlet 66 and channel outlet 68 disposed within at least one of the chip left edge 14, right edge 16, top surface 26, and bottom surface 28.

In an embodiment, chip 10 comprises a plurality of microstructure features disposed within the chip volume. In an embodiment, at least one microstructure is a micro-channel 64 connecting a non-channel microstructure to one of a channel inlet 66 and channel outlet 68. The non-channel microstructure may be a reservoir, pump, valve or reaction chamber. As would be recognized by one of skill in the art, it is within Applicants' description that embodiments of the chip 10 comprise a plurality of independent micro-channels and/or micro-channel connected features. Advantageously, such embodiments provide a plurality of diagnostic functional tools within a single chip. In an embodiment, the channel wall 70 is substantially smooth along at least a portion of its length 72. Advantageously, smooth-walled portions of the channel reduce turbulence in fluid flowing within the micro-channel 64.

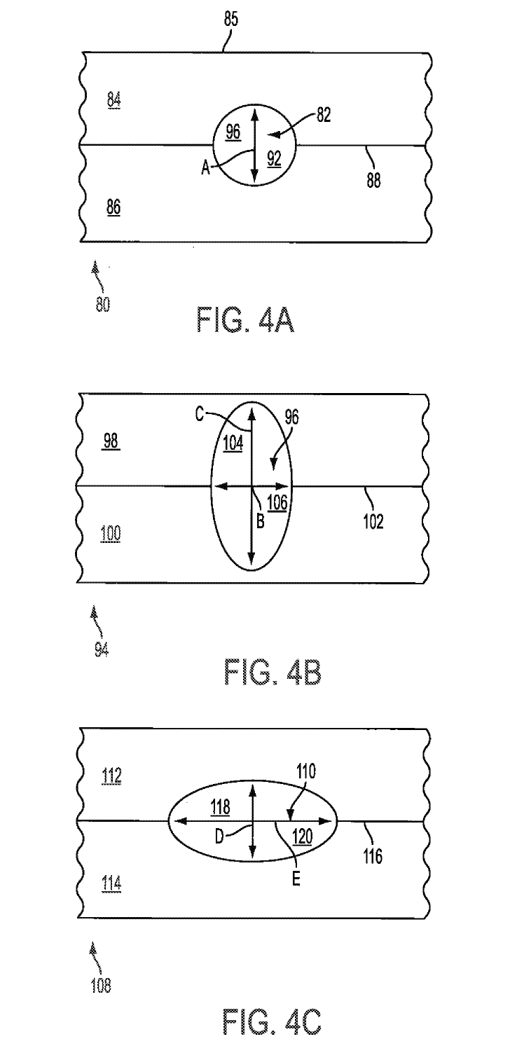

FIGS. 4A-4C illustrate different channel cross-sections of the embodiments of micro-channel 64. FIG. 4A shows a cross-sectional view of a chip 80 comprising a micro-channel 82 having a substantially circular cross-section, a first substrate 84, a second substrate 86, and an interface 88. Channel 82 is disposed within a volume of chip 80, and has a diameter A. Channel 82 comprises a channel upper portion 86 and a channel lower portion 88. Upper channel portion 86 defines a recess in first substrate 90; channel lower portion 88 defines a complementary recess in second substrate 92. As shown in FIG. 4A, upper and lower channel portions (86, 88) are respectively disposed with the respective substrates (84, 86) such that, when the substrates (84, 86) are joined, the semicircular cross-sections of upper and lower channel portions (86, 88) cooperatively define a channel having a substantially circular cross-section. Upper channel portion 86 and lower channel portion 88 are aligned in position with respect to each other in the x-direction and y-direction such that the channel wall is smooth about the channel circumference, including at the interface 88. The upper and lower channel portions are aligned in position with respect to one another in the z-direction such the channel upper portion 90 overlays lower portion 92, and is smooth about its circumference along at least a portion of the channel length.

FIG. 4B shows a cross-sectional view of a chip 94 comprising a micro-channel 96 having a substantially oval cross-section, a first substrate 98, a second substrate 100, and an interface 102. Channel 96 is disposed within a volume of chip 94, and comprises a minor diameter B and a major diameter C. Channel 96 further comprises an upper channel portion 104 and a lower channel portion 106. Upper channel portion 104 defines a recess in the first substrate 98; lower channel portion 106 defines a recess in the second substrate 100. The recesses 104, 106 cooperatively define the cross-section of channel 96 having a rounded shape. As shown in FIG. 4B, the upper and lower channel portions 104, 106 each define substantially half-oval cross-sections, each portion being respectively disposed in a substrate 98, 100 so as to cooperatively define an oval cross-section. Upper channel portion 104 and lower channel portion 106 are aligned in position in the x-direction and y-direction with respect to one another such that the channel wall presents a substantially smooth wall surface. The upper and lower channel portions 104, 106 are aligned in the z-direction with respect to one another such that the upper channel portion 104 overlays the lower channel portion 106, thereby presenting a smooth wall to channel fluid along at least a portion of its length.

FIG. 4C shows a cross-sectional view of a chip 108 comprising a micro-channel 110 having a substantially oval cross-section, a first substrate 112, a second substrate 114, and an interface 116. Channel 110 is similar to channel 96 with difference that the channel cross-section is clocked (rotated) with an axis running the length of the channel. Channel 110 in clocked around 90 degrees relative to the channel axis. However, in alternate embodiments, the channel 110 may be clocked at an angle suited to a particular chip application. Moreover, the channel cross-section may be clocked at differing angles along its length, such as to accommodate other microstructures disposed within the chip volume.

in an embodiment of a channel 64, at least one of the channel diameter, minor axis, and major axis has a length of approximately 75 microns (0003 inches). In an exemplary embodiment the channel diameter is 75 microns, advantageously providing a chip having channel length between 40 millimeters and 100 millimeters (1.6 inches to 4 inches) disposed within a chip having an approximately 5 millimeter by 5 millimeter (0.2 inch by 0.2 inch) footprint. Such channel length advantageously provides sufficient length such that both the stationary and mobile phases of the fluid may be observed with an optical microscope. Registering the upper and lower channel portions 90, 92 such that upper channel portion 90 overlays the lower channel portion 92 and provides a smooth-walled channel, thereby minimizing turbulent flow of fluid moving within the channel 64, thereby allowing for optical observation of fluid moving within the channel 64 possible with an optical microscope.

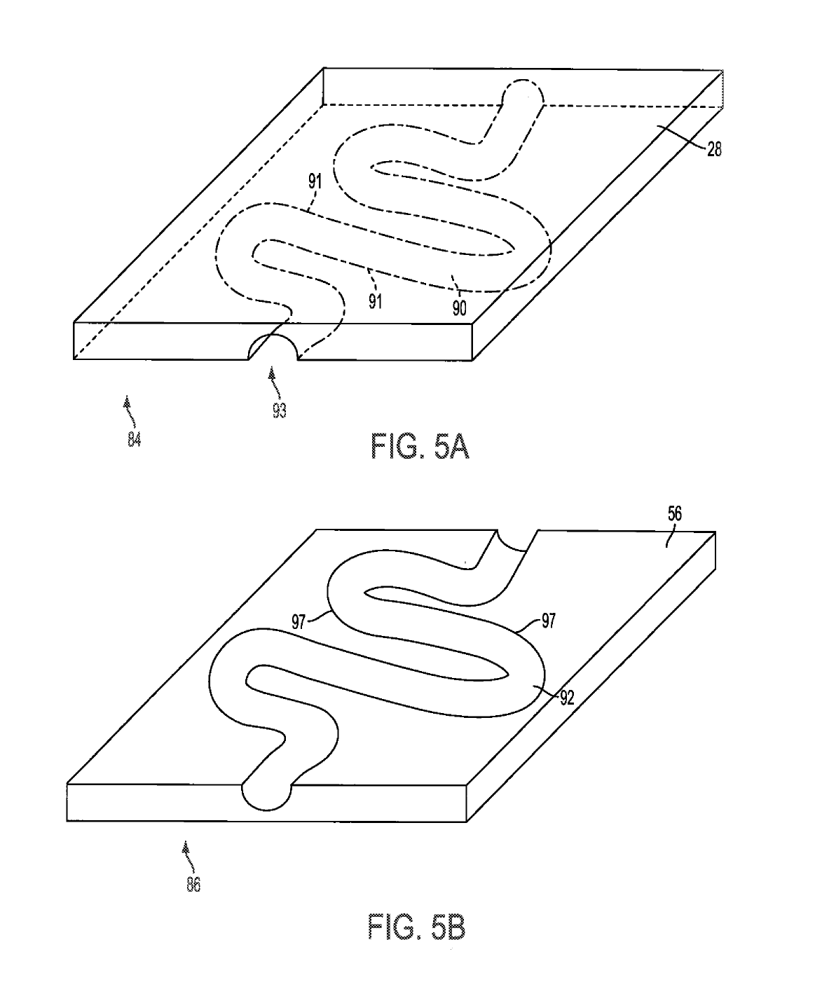

FIG. 5A and FIG. 5B show perspective views of substrates having complementary recesses. FIG. 5A shows the chip first substrate 84. First substrate 84 comprises the channel upper portion 90. Upper portion 90 defines a recess 91 (illustrated in dotted outline) disposed in the first substrate 84, the recess 91 opening downwardly toward substrate bottom surface. First substrate 84 comprises the chip top surface 28, a portion of the chip front edge, a portion of the chip back edge, a portion of the chip right edge, and a portion of the chip left edge. The upper channel portion 90 further defines a portion of an aperture 93 in the chip front face, the aperture defining an inlet 66 to the chip 10. Similarly, the upper portion 90 further defines a portion of an aperture in the chip rear face, the aperture defining an outlet 68 from the chip. The location of the channel inlet 66 and channel outlet 68 in the illustrated embodiment are for illustration purposes only, and are non-limiting; embodiments of the channel 64 may have the inlet 66 and outlet 68 located in any of the chip edges, faces, surfaces, or may be wholly within the chip volume so as to fluidly connect other microstructures located within the chip 10.

FIG. 5B shows the chip second substrate 86. Second substrate 86 comprises the lower channel lower portion 92. Lower portion 92 defines a recess 97 (illustrated in solid outline) disposed in the second substrate 86 opening toward the substrate top surface 56. The second substrate recess 97 compliments (mirrors) the first substrate recess 91. Second substrate 86 further comprises the chip bottom surface, a portion of the chip front edge, a portion of the chip back edge, a portion of the chip right edge, and a portion of the chip left edge. The channel lower portion 92 further defines a corresponding (complementary) portion to the above-discussed aperture 93 in the chip front edge 20, the aperture defining the inlet 66 of the channel 64. Similarly, the upper portion 90 defines a corresponding portion of the above-discussed aperture 93 that defines the outlet 68 of the channel 64.

In an embodiment, at least one of the substrates (84, 86) comprises borosilicate glass. Borosilicate glass is commercially available as Corning 7740 glass (marketed under the Pyrex™ trade name by Corning Inc. of Corning, N.Y. in numerous forms, including as 4 inch wafers. Borosilicate glass is also available as Schott 8830 glass (marketed under the Duran™ trade name by the Schott AG of Mainz, Germany). Advantageously, glass substrates are optically transparent, and allow for observation of fluid within a channel having a least a portion fabricated from glass. Advantageously, in an exemplary embodiment, the micro-channel 64 has serpentine-shaped length in the range to and including approximately 40 millimeters and 100 millimeters. In an embodiment, the micro-channel 64 is optically accessible through at least one of substrate, thereby allowing for observation of both a stationary and mobile phase of fluid within the channel using an optical microscope. In an embodiment, the optical microscope is coupled to chip 10, thereby providing a laboratory-on-a-chip suitable for in-situ planetary exploration.

In an embodiment, at least one of the substrates (84, 86) comprises silicon. One such silicon type in electronic grade silicon (99.99% pure), commercially available from MEMC Electronic Materials of St. Peters, Mo. in 4 inch wafer form. As discussed above, fabricating the second substrate from silicon facilitates the integration other electronic components into the chip. In an exemplary embodiment, the second substrate 36 comprises silicon and the first substrate 34 comprises glass, thereby allowing (i) optical observation of a fluid moving within the channel, (ii) integration of electronics directly into the substrate that may directly engage the fluid within the micro-channel, and (iii) an interface region comprising an anodic bond (joint) rigidly fixing the substrates together.

Advantageously embodiments of an LOC comprising a borosilicate first substrate and silicon second substrate can withstand most acid and base environments. It is generally understood that tolerance of relatively acidic and/or basic environments provides a microfluidic device resistant to chemically harsh environments. Advantageously, exemplary embodiments of chips comprising glass and silicon substrates having tolerance for extreme acid and base environments provide lab-on-a-chip devices suitable for in-situ planetary science.

Advantageously, embodiments of chip 10 comprising a borosilicate glass and silicon provide a lab-on-a-chip containing substantially no organic materials. Such chips therefore cannot be a source of organics detected in fluid within the chip 10, therefore providing certainty as to the foreign origin of organics detected during in-situ planetary science.

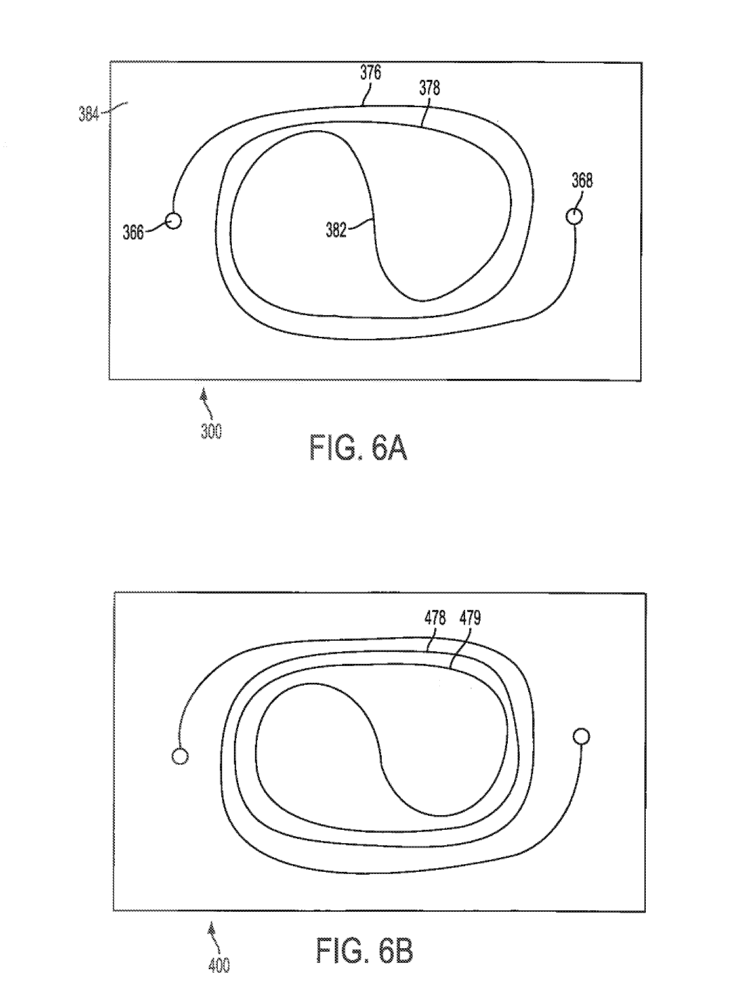

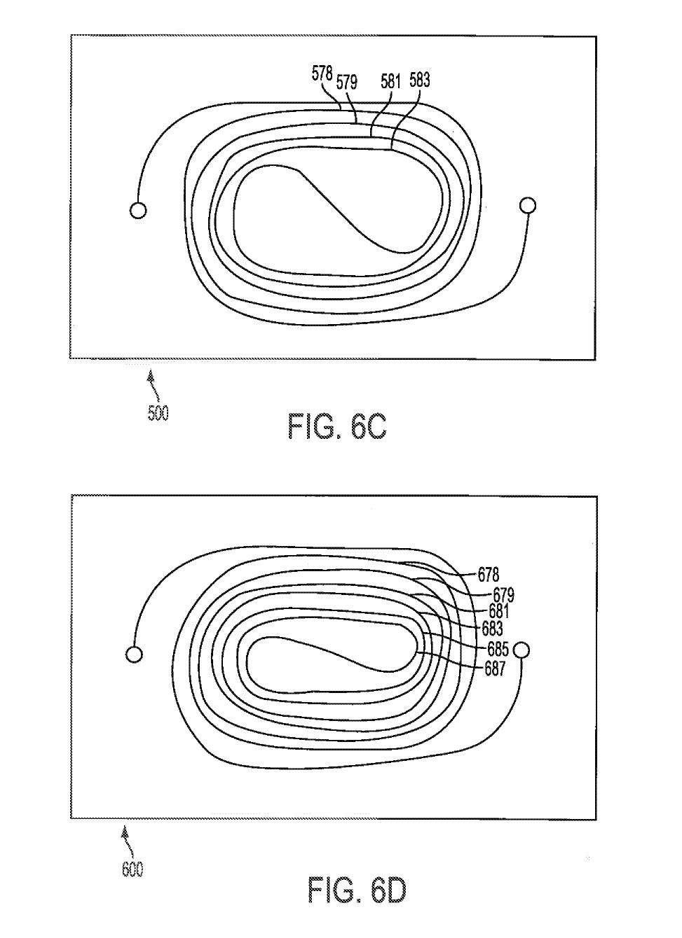

FIGS. 6A-6D show exemplary embodiments of chip containing a microchannel. As shown in FIG. 6A, a chip 300 comprises a first substrate 384 fabricated from glass. The first substrate 384 is optically transparent, thereby providing an optically accessible microchannel 382. The microchannel 382 further comprises and inlet 366 and an outlet 368, the inlet 366 and outlet 368 extending from the first substrate surface 384 to the microchannel 382. In an embodiment, at least one of the inlet 366 and outlet 368 have a conical shape. In the embodiment shown, the conical inlet 366 and outlet 368 are tapered, and have a first cross-sectional area at the first substrate surface 384 and a second cross-sectional area at the intersection of inlet/outlet with the microchannel 382. Advantageously, chips having an inlet and outlet with a conical shape in the glass substrate can withstand an channel internal pressure greater than 4,000 psi. Conical shaped inlets and outlets also provide a chip that can be connected to an external device using capillary tubes without glue.

As shown in FIG. 6A, chip 300 have a single pair of predecessor and successor channel portions (376, 378). Overlapping channel portions as shown in FIG. 6A provides a chip 300 having about a serpentine-shaped channel with a length of around 40 mm and a channel cross-sectional area of about 75 microns in a chip die size of around 5 mm by 10 mm.

FIG. 6B shows an exemplary embodiment of a chip 400 having a plurality of overlapping successor channel portions (478, 479). Overlapping channel portions as shown in FIG. 6B provides a chip 400 having about a serpentine-shaped channel with a length of around 60 mm and a channel cross-sectional area of about 75 microns in a chip die size of around 5 mm by 10 mm.

FIG. 6C shows an exemplary embodiment of a chip 500 having three overlapping successor channel portions (478, 479, 481). Overlapping channel portions as shown in FIG. 6C provides a chip 500 having about a serpentine-shaped channel with a length of around 80 mm and a channel cross-sectional area of about 75 microns in a chip die size of around 5 mm by 10 mm.

FIG. 6D shows an exemplary embodiment of a chip 600 having three overlapping successor channel portions (578, 579, 581, 583, 585, 587). Overlapping channel portions as shown in FIG. 6D provides a chip 600 having about a serpentine-shaped channel with a length of around 100 mm and a channel cross-sectional area of about 75 microns in a chip die size of around 5 mm by 10 mm.

The embodiments shown in FIGS. 6A-6D are for illustration purposes only, and non-limiting, and serve to show the relationship interplay of channel length, channel cross-section, and chip size when successive portions of the serpentine-shaped channel are overlapped as shown in the figures. Other combinations of channel cross-section, channel length, and chip size come within the scope of Applicant's disclosure.

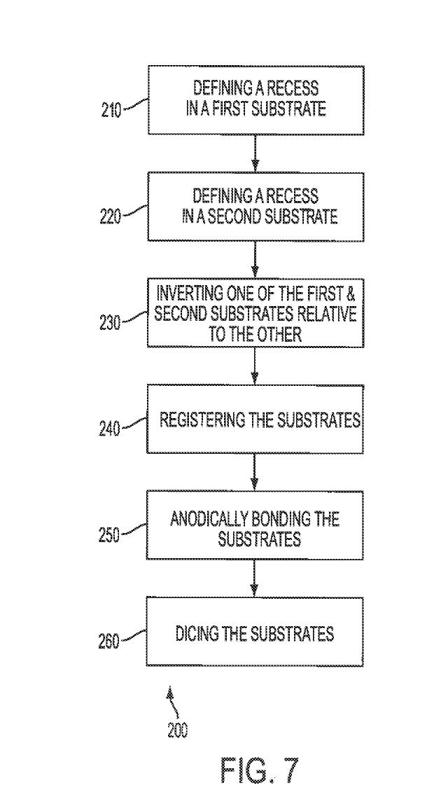

FIG. 7 shows one embodiment of an exemplary method 200 of fabricating a chip 10 having at least one micro-channel 64. The method comprises defining 210 a recess in a surface of a first substrate, defining 220 a recess in a surface of a second substrate, inverting 230 the second substrate with respect to the first substrate, registering 240 the second substrate relative to the first substrate such that the recess in the surface of the second substrate overlays the recess in the surface of the first substrate, anodically bonding 250 the registered surface of the second substrate to the surface of the first substrate, and dicing 260 the bonded substrate into at least one chip. As would be recognized by one of ordinary skill in the art, the order of certain operations in the method shown in FIG. 7 may be altered and remain within the scope of the present disclosure. For example, the defining 220 a recess in a surface of a second substrate operation may be performed prior to or coincident to the defining 210 a recess in a surface of a first substrate operation.

The defining 210 of a recess in a surface of the first substrate and defining 220 of a recess in a surface of a second substrate serves to instill a common, complimentary recess pattern in the surface of the substrates. Thus, when the substrates are subsequently inverted, the recesses mirror one another when aligned in position (i.e. registered), thereby cooperatively defining a chip microstructure such as a micro-channel. In an exemplary embodiment, a single mask may be used to instill patterns in both substrates to ensure matching recess patterns. In another embodiment, different masks are used to define a recess pattern, thereby accommodating etch processes appropriate for disparate substrate materials.

In an exemplary embodiment, at least one of the defining 210 a recess in a surface of a first substrate and defining 220 a recess in a surface of the second substrate is done using an anisotropic deep reactive ion etch. Advantageously, the anisotropic deep reactive ion etch defines a recess in substrates having a high aspect ratio, “aspect ratio” as used herein meaning the ratio between a depth and a width of the recess. Advantageously, such anisotropic etching produces a recess having substantially vertical sidewalls. Vertical sidewalls, in turn, create a prominent edge at the interface of the recess sidewall and substrate surface, which in turn facilitates the bonding operation discussed below. Such etching may be done to disparate substrate materials, including glass and silicon. In an exemplary embodiment, removable mask is applied to at least one substrate surface prior to the etching process, thereby defining the serpentine shape of the recess. In another embodiment, a common mask pattern is transferred to a removable pattern coating the substrate, thereby replicating a single recess pattern to a plurality of chips.

In an exemplary embodiment, at least one of the defining 210 a recess in a surface of a first substrate and defining a recess 220 in a surface of the second substrate is done using isotropic Xenon diflouride (XeF₂) dry etching. Advantageously, such dry etching has a high selectively for certain elements and compounds, including silicon. In one embodiment, a removable mask may be applied to the surface of the substrate prior to etching to define the geometry of the recess. As would be recognized by one of ordinary skill in the art, process tools currently available for microelectronics manufacturing are readily adaptable to defining recesses in glass in silicon wafers for defining micro-channel features.

In an exemplary embodiment, at least one of the defining 210 a recess in a surface of a first substrate and defining 220 a recess in a surface of the second substrate is done using wet hydrofluoric acid (HF) etching. Advantageously, such etching effectively removes silicon dioxide (SiO₂) commonly found on the surface of electronic grade silicon wafers. In one embodiment, a removable mask may be applied to the surface of the substrate prior to etching to define the geometry of the recess. As would be recognized by one of ordinary skill in the art, process tools currently available for microelectronics manufacturing are readily adaptable to defining recesses in glass in silicon wafers for defining micro-channel features.

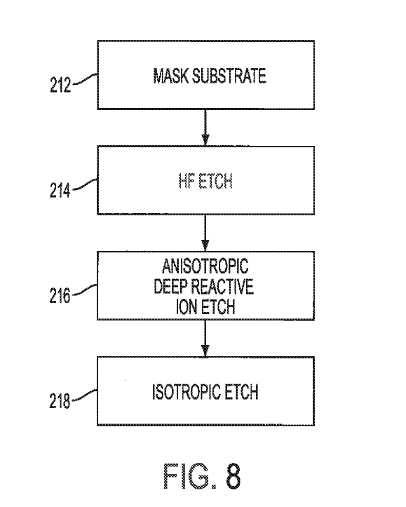

FIG. 8 shows an exemplary embodiment of the defining operation of FIG. 7 using a succession of etch processes on a single substrate. In a masking operation 212, an outline of a micro-channel is defined on the substrate surface. In a first etching operation 214 an HF etch is applied to the substrate, thereby removing a substrate coating such as a silicon dioxide. In a second etching operation 216 anisotropic deep reactive ion etch deepens the recess, thereby defining a recess having a high aspect ratio by deepening the recess. In a third etching operation 218 an isotropic etch further defines the recess, uniformly deepening and widening the recess. The resulting recess has a substantially half oval-shaped cross-section. And as would be recognized by one of ordinary skill in the art, the above discussed etching process order may be altered and steps repeated as necessary to obtain recess profile desirable for an intended application.

The inverting 230 the second substrate relative to the first substrate mechanically orients the recesses toward one another such that the surface of the second substrate opposes the surface of the first substrate. As such, when the substrates are joined at a common interface, both recesses cooperatively define a common cannula or channel volume.

The registering 240 the second substrate to the first substrate causes the substrates to be aligned in position substantially along at least a portion of the length of at least one serpentine-shaped micro-channel. In an embodiment, each of the defining a recess (210, 220) operations discussed above further comprises defining at least one registration mark in substantially the same relative location on the first and second substrates.

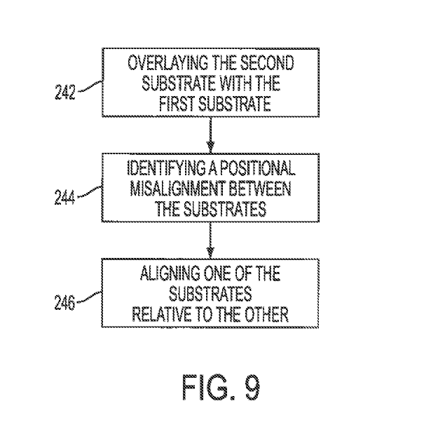

FIG. 9 shows an exemplary embodiment of registering operation of FIG. 7 whereby the substrates are aligned in position prior to bonding. Advantageously, in embodiments where the second substrate is optically transparent, registering the second substrate to the first substrate further comprises overlaying 242 the second substrate mark over the first substrate, identifying 244 a relative misalignment of the substrates by viewing the second substrate mark and the first substrate mark through the second substrate in a common image, and aligning 246 the position of one of the substrates relative to the other to correct the relative misalignment by at least one of changing at least one of an x-shift, y-shift, and rotation of one substrate relative to the other substrate. Advantageously, in embodiments where the second substrate is optically transparent, registering the second substrate to the first substrate further comprises (i) overlaying the second substrate recess over the first substrate recess, (ii) identifying a relative misalignment of the substrates by viewing the radius 74 of the recess of the second substrate mark and a corresponding radius 74 of the first substrate recess in a common image, and (iii) aligning the substrates to connect the relative misalignment by at least one of changing at least one of an x-shift, y-shift, and rotation of one substrate relative to the other substrate based. Such alignment strategy advantageously eliminates the need to occupy chip surface with a registration mark, thereby freeing chip surface for other microstructure(s).

The anodically bonding 250 the registered second substrate to the first substrate rigidly fixes the substrates together into a single structure. Because the substrates are aligned in position when anodically bonded together, the recesses (90, 92) cooperatively define a micro-channel that is hermetically sealed from the environment outside the chip substantially along the length of the micro-channel, and volume contained therein accessible only through the channel inlet and outlet.

Advantageously, an embodiment of anodically bonding the substrates bonds the second substrate directly to the first substrate without an intermediate layer. This creates an extremely strong bond between the substrates, thereby enabling the micro-channel to withstand a maximum internal pressure in excess of 276 bar (4,000 psi) with a leak rate of less than 0.01 microlitres per minute. Anodically bonding the first substrate to the second substrate further provides an aperture of sufficient radial strength that a fitting received within the aperture does not disturb the joint between the substrates. In an embodiment, a ferrule received within the aperture having a tapered length engages the periphery with sufficient strength both sustain a max channel pressure in excess of 276 bar and not disturb the joint between the substrates.

In an exemplary embodiment, the channel inlet and outlet are defined in the glass substrate. The inlet and outlet may have a conical shape, and in an embodiment, the conically-shaped inlet and/or outlet complements the shape of a ferrule received within the inlet/outlet. Advantageously, a conically-shaped inlet and/or outlet formed in the glass substrate enables the microchannel to withstand an internal pressure of at least 4,000 psi. Advantageously, such a conically-shaped inlet and/or outlet defined in the glass substrate allows for capillary tube to be connected to the device without glue. Eliminating glue from capillary tubes connected to the chip in turn eliminates a potential source of organic compounds detected in the microchannel. This which is desirable for in-situ planetary science, where identification of organic compounds within the channel may be of significance.

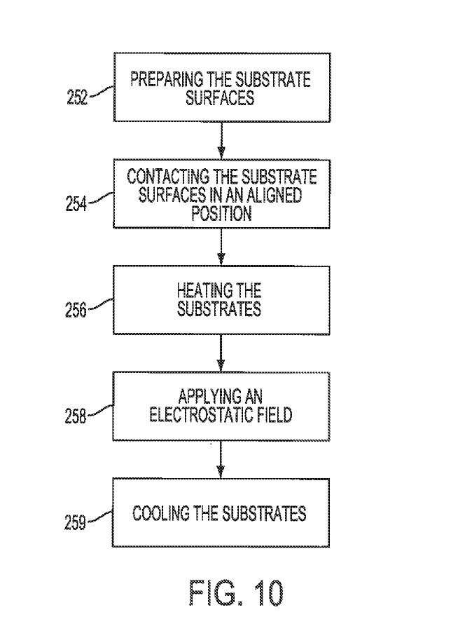

FIG. 10 shows an exemplary embodiment of a process for the anodically bonding process 250 of FIG. 7 whereby the substrates are rigidly fixed together in a positionally aligned relationship. In the embodiment, the anodically bonding 250 the substrates further comprises preparing 252 the substrate contact surfaces; contacting 254 the substrate surfaces in an aligned position; heating 256 the contacted substrates; 258 applying an electrostatic field to the heated substrates; and cooling 259 the substrates. Preparing the substrate surfaces may further comprise uniformly removing a layer such as a silicon oxide layer, polishing (planarizing) the substrate surface, and cleaning the substrate surface. Contacting the substrates may further comprise placing the surfaces into atomic contact and placing a cathode in contact with at least one of the substrates. Heating the contacted surfaces may comprise raising the substrates to a temperature of approximately 350-400 degrees C. Applying an electrostatic field may further comprise applying an electric potential on the order of several 100V such that oxygen ions drift out of the glass substrate and react with second substrate. In an embodiment, the second substrate is silicon and oxygen ions react with the silicon substrate to form SiO₂.

In an embodiment, at least one of the substrates comprises a 100 millimeter (4 inch) wafer. Advantageously, use of 4 inch wafers allow for a single iteration of the above-discussed method to yield 72 individual microfluidic devices having a die size of 5 millimeters by 5 millimeters, thereby enabling the manufacture of the devices in large numbers. As would be recognized by one of ordinary skill in the art, embodiments of the above-described method include processes using larger wafer sizes, such as 200 millimeter (8 inch) and 300 millimeter (12 inch) wafers.

Thus, while there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of making a microfluidic device, the method comprising:
defining a recess in a surface of a first substrate comprising a first material;
defining a recess in a surface of a second substrate comprising a second material;
inverting the second substrate relative to the first substrate;
registering the second substrate to the first substrate such that the recess in the surface of the first substrate overlays the recess in the surface of the second substrate; and
anodically bonding the second substrate to the first substrate.

2. The method of claim 1, further comprising:
dicing the bonded substrates into a chip;
wherein a micro-channel is formed in the chip from the recess in the surface of the first substrate and the recess in the surface of the second substrate.

3. The method of claim 2, the micro-channel comprising an inlet and an outlet, and inserting a deformable ferrule into the inlet and the outlet of the micro-channel.

4. The method of claim 2, further comprising testing the at least one micro-channel by integrating the chip into a nano-chromatography instrument.

5. The method of claim 2, comprising pressure testing the micro-channel.

6. The method of claim 10, wherein the micro-channel is configured to withstand an internal pressure of 4,000 pounds per square inch with a leak rate of less than 0.01 microlitres per minute.

7. The method of claim 1, wherein the one of the first and second materials comprises a borosilicate glass and wherein one of the first and second materials comprises electronics grade silicon.

8. The method of claim 2, wherein the micro-channel has a serpentine shape and a substantially oval cross-section.

9. The method of claim 4, wherein the chip is has a 5 millimetre by 10 millimetre footprint, the micro-channel has a diameter of about 75 microns, and a length of the micro-channel is between 40 millimetres and 100 millimetres.

10. The method of claim 4, wherein the substantially oval cross-section of the micro-channel occupies at least a portion of a cross-section of the first substrate and at least a portion a cross-section of the second substrate.

11. The method of claim 1, wherein each of the defining a recess in the first substrate and defining a recess in the second substrate comprises an anisotropic deep reactive etch, an isotropic Xenon diflouride dry etch, and a wet hydrofluoric acid etch.

12. A microfluidic device, comprising:
a first substrate having a recess; and
a second substrate having a recess, the second substrate being anodically bonded to the first substrate,
wherein the second substrate is aligned to the first substrate such that the first substrate recess and the second substrate recess cooperatively define a micro-channel,
wherein the micro-channel comprises a cross-section having a substantially oval shape along at least a portion of a length of the micro-channel, the micro-channel having an inlet, an outlet, and a length
wherein the length of the micro-channel has a serpentine shape along at least a portion of the length between the inlet and the outlet.

13. The device of claim 12, wherein the micro-channel cross-section has a minor axis and a major axis, the major axis being longer than the minor axis, and the major axis being orthogonal to the bond between the substrates.

14. The device of claim 3, wherein the major axis has a length of 75 microns.

15. The device of claim 12, wherein the length of the micro-channel is between 40 millimetres and 100 millimetres.

16. The device of claim 12, wherein the micro-channel contains functionalized microbeads, the microbeads being configured to separate at least a first molecular species from a fluid introduced into the micro-channel.

17. The device of claim 12, wherein the first substrate is constructed from glass and wherein the inlet and the outlet are disposed within the first substrate.

18. The device of claim 17, wherein at least one of the inlet and outlet has a conical shape.

19. The device of claim 17 wherein at least one of the inlet and outlet has a conical shape comprising a first cross-section on the substrate surface and a second cross-section at the micro-channel, the first cross-section being greater than the second cross-section.
